(19) United States
(12) Patent Application Publication
(10) Pub. No.: US 2026/0087200 A1
(43) Pub. Date: Mar. 26, 2026

(54) PREDICTIVE ENERGY PLATFORM WITH DIGITAL TWIN

(71) Applicant: QSecGrid, Inc., New York, NY (US)

(72) Inventors: Gordon R. WINSTON, Katonah, NY (US); John-Philip GALINSKI, Forest Hills, NY (US); Nigel WALKER, Ponteland (GB); Mark THOMPSON, Blyth (GB); Patrick J.D. SANTOS, Kirkland, WA (US)

(21) Appl. No.: 19/274,109

(22) Filed: Jul. 18, 2025

Related U.S. Application Data
(60) Provisional application No. 63/699,116, filed on Sep. 25, 2024.

(51) Int. Cl. G06F 30/20; G06F 40/30; G06F 113/04

(52) U.S. Cl. CPC G06F 30/20; G06F 40/30; G06F 2113/04

(57) ABSTRACT

The present invention related to a method and a predictive energy platform for generating a predictive digital twin for at least one power grid. The method may include receiving one or more energy resource operational attributes, from at least one profile manager, corresponding to a plurality of integrated distributed energy resources (IDERs). The method may further include generating, using at least one digital twin model, at least one digital twin of the at least one power grid by creating at least one energy network graph based on the received one or more energy resource operational attributes corresponding to the plurality of IDERs. The method may further include integrating external data with the at least one generated energy network graph for benefit of generating at least one analysis product.

### RELATED APPLICATION

This application claims priority to a commonly owned, U.S. Provisional Patent Application No. 63/699,116, filed on Sep. 25, 2024, and titled “Predictive Energy Management”, which is herein incorporated by reference in its entirety.

### TECHNICAL FIELD

Embodiments of the present invention generally relate to energy management, and more particularly to a predictive energy platform using digital twinning.

### BACKGROUND

Energy management can support a stable, efficient, and/or sustainable power supply. Conventional energy management systems encompass a range of strategies, technologies, and policies aimed at optimizing energy generation, and distribution. Some conventional systems facilitate demand response and predictive modeling. Some conventional energy management systems enable real-time monitoring of energy resources to improve energy management.

Some conventional energy management systems lack capabilities to enable consumers and/or energy network operators reliant on conventional static models and/or historical trends to guide decision-making.

There is thus a need for a system and method for managing energies in a more efficient and/or effective manner.

### BRIEF DESCRIPTION OF THE DRAWINGS

Features and advantages of embodiments of the present invention will become apparent upon consideration of the following detailed description of embodiments thereof, especially when taken in conjunction with the accompanying drawings, in which:

FIG. 1 is a block diagram depicting an exemplary computing environment that facilitates simulation of a power grid in accordance with at least one embodiment of the present invention.

FIG. 2 is an exemplary functional block diagram of components of an energy management system in accordance with at least one embodiment of the present invention.

FIG. 3 is an exemplary functional diagram of a simulation engine in accordance with at least one embodiment of the present invention.

FIG. 4 is an exemplary energy network graph in accordance with at least one embodiment of the present invention.

FIG. 5 is an exemplary process of generating a digital twin in accordance with at least one embodiment of the present invention.

FIG. 6 is an exemplary process of generating analysis products using a digital twin in accordance with at least one embodiment of the present invention.

FIG. 7 is an exemplary process of detecting impact using a digital twin in accordance with at least one embodiment of the present invention.

FIG. 8 is a schematic diagram illustrating aspects of an example computer in accordance with at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, “includes”, “such as”, “for instance”, and “for example” mean “including but not limited to”. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

A method for generating a predictive digital twin for at least one power grid is disclosed. The method may include receiving one or more energy resource operational attributes, from a predictive energy platform, corresponding to a plurality of integrated distributed energy resources (IDERs). The method may further include generating, using at least one digital twin model, at least one digital twin of the at least one power grid at least in part by creating at least one energy network graph based on the received one or more energy resource operational attributes corresponding to the plurality of IDERs. The method may further include integrating external data with the at least one generated energy network graph for generating at least one analysis product.

A predictive energy platform for generating a predictive digital twin for at least one power grid is disclosed. The predictive energy platform may include at least one profile manager configured to receive one or more one or more energy resource operational attributes corresponding to a plurality of integrated distributed energy resources (IDERs). The predictive energy platform may further include at least one digital twin model configured to correspond to at least one digital twin of the at least one power grid at least in part by incorporating at least one energy network graph based on the received one or more energy resource operational attributes corresponding to the plurality of IDERs. The predictive energy platform may further include a data integration engine configured to incorporate external data with the at least one generated energy network graph for generating at least one analysis product.

One or more computer-readable media, collectively storing instructions that, when executed by one or more processors, collectively may cause one or more computing devices to at least receive one or more energy resource operational attributes, from at least one profile manager, corresponding to a plurality of integrated distributed energy resources (IDERs). The one or more non-transitory computer-readable media may further cause the computing device to generate, using at least one digital twin model, at least one digital twin of the at least one power grid by creating at least one energy network graph based on the received one or more operational attributes corresponding to the plurality of IDERs. The one or more non-transitory computer-readable media may further cause the computing device to integrate external data with the at least one generated energy network graph for generating at least one analysis product.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein.

The term “automatic” and variations thereof, as used herein, refers to any suitable process or operation done independent of material human input when the process or operation may be performed. However, a process or operation can be automatic, even though performance of the process or operation uses material or immaterial human input, if the input may be received before performance of the process or operation. Human input may be deemed to be material if such input influences how the process or operation will be performed. Human input that consents to the performance of the process or operation may not be deemed to be “material.”

The term “determine” and variations thereof, as used herein, may include any suitable type of methodology, process, operation, and/or technique. Such determinations may include calculations and/or computations.

The term “energy source” and variations thereof, as used herein, may be defined as an entity or mechanism capable of and/or responsible for generating or supplying energy. The energy source may include renewable energy sources such as solar panels, wind turbines, and hydroelectric plants, or non-renewable energy sources such as fossil fuel-based generators and nuclear power plants, as well as energy storage devices and facilities such as batteries.

The term “energy consumer” and variations thereof, as used herein, may be defined as an entity, machine, device, or mechanism that consumes and/or dissipates energy. At times, the term may be used to reference a responsible person or entity that utilizes or draws energy. Examples of energy consumers may include an individual, a business, a utility company, or a grid operator. One or more energy consumers may be associated with an energy profile. The energy consumers may be residential users, commercial establishments, industrial facilities, electric vehicle charging stations, healthcare facilities, industries, utility companies, and so forth, in an embodiment of the present invention. The energy consumers may also include energy brokers, energy storage systems, and microgrid operators that may consume, store, or redistribute energy, in another embodiment of the present invention. Additionally, the energy consumers may involve entities that may participate in energy lending, energy borrowing, or trading markets, as well as those who may seek to optimize their energy usage based on sustainability goals, in yet another embodiment of the present invention. Embodiments of the present invention are intended to include or otherwise cover any suitable energy consumers.

Further examples of the energy consumers may include energy-associated machines, that may be heat pumps, Heating, Ventilation, and Air Conditioning (HVAC) systems, electrical appliances such as, refrigerators, washing machines, dishwashers, ovens, and microwaves, generators, electric vehicles, battery storage systems, lighting systems such as LED lights, streetlights, and emergency lighting, air conditioners, water heaters, industrial machinery, such as conveyor belts, pumps, and compressors, automated manufacturing equipment, data centers, computers, mobile phones, smart gadgets, servers, processors, smart home devices, such as, thermostats, smart plugs, and security systems, agricultural equipment, such as irrigation pumps and greenhouse climate control systems, electric forklifts, electric-powered construction tools, electric motors in various applications, medical devices such as oxygen machines, ventilators, diagnostic imaging equipment (e.g., MRI and CT scanners), infusion pumps, patient monitoring systems, and other critical healthcare infrastructure powered by electrical systems and so forth. Embodiments of the present invention may be intended to include or otherwise cover any suitable type of the energy-associated machines, including known, related art, and/or later developed technologies.

The term “energy storage facilities” and variations thereof, as used herein, may be defined as infrastructure, systems, and/or energy-associated machines and/or devices that may be capable of storing energy. The storage facilities may function both as energy consumers and energy sources, dynamically shifting roles as needed based on one or more demands, supply conditions, grid requirements, and so forth.

The term “energy management system user” and variations thereof, as used herein, may be defined as a person or an entity that engages with an energy management system. Such energy management system users may perform functions such as viewing, managing, and/or analyzing energy transactions, generating reports, and/or facilitating energy trading. The energy management system user may interact with the energy management system through a user interface, and the interactions may be logged for audit and compliance purposes.

The term “energy management system administrator” and variations thereof may refer to a person or an entity with advanced access rights within Integrated Distributed Energy Resources (IDERs) of a power grid. The energy management system administrator may be responsible for configuring system settings, managing access controls, managing data integrity, overseeing regulatory compliance, maintaining overall system security, and so forth. Additionally, the energy management system administrator may simulate operational scenarios, execute mock drills for emergency response, analyze system resilience, and/or implement modifications to enhance grid stability. The energy management system administrator may also audit transactions, adjust system parameters, troubleshoot technical issues, and coordinate with relevant stakeholders. All actions performed by the energy management system administrator may be logged within the energy management system.

The term “energies” and variations thereof, as used herein, may be defined as various forms of energy, including electrical energy generated from renewable and non-renewable energy sources. The energies may be categorized based on their provenance of generation, such as solar, wind, hydro, fossil fuel, or nuclear, and may be tracked, managed, and traded within the energy management system.

The term “energy resource operational attributes” and variations thereof may be defined as parameters and/or characteristics that can influence functioning and/or performance of one or more integrated distributed energy resources (IDERs) within a power grid. Examples of the energy resource operational attributes may include power generation capacity, energy consumption rate, energy transfer sampling rate, load demand patterns, voltage/frequency stability, fault tolerance levels, response time to anomalies, grid reconfiguration strategies, energy storage utilization, cybersecurity protocols, efficiency of automated restoration mechanisms, and so forth. Examples of the energy resource operational attributes may also include real-time monitoring metrics, predictive analytics for system optimization, and/or adaptive control mechanisms to enhance grid resilience under varying operational conditions.

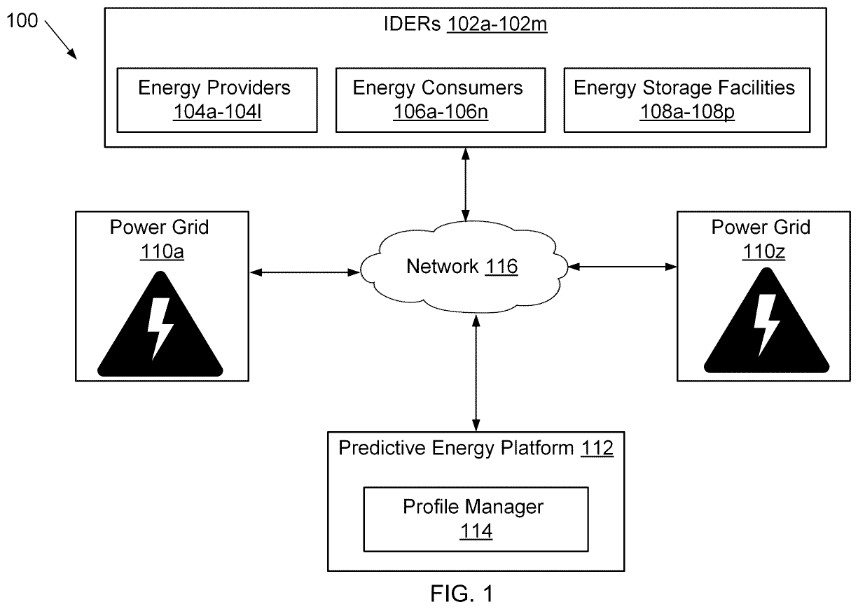

FIG. 1 depicts an exemplary computing environment 100 that may be configured to facilitate simulation of one or more power grids, according to at least one embodiment of the present invention. The computing environment 100 may be capable of managing, organizing, and simulating energy-related transactions. The energy-related transactions may be, for example, an energy generation (i.e., an internal or an external), an energy consumption, an energy transfer, energy storage updates including charging and discharging of an energy storage facility, an energy lending, an energy borrowing, an energy balancing, energy trading activities, energy reconciliation, and so forth. The energy-related transactions may include energy exchanges between different parties, adjustments to energy inventories, and updates to energy credits or debits across various systems.

The computing environment 100 may be configured to enable an integration of a plurality of Integrated Distributed Energy Resources (IDERs) 102a-102m within distributed energy networks. In an embodiment of the present invention, the plurality of IDERs 102a-102m (hereinafter referred to as “IDER 102” or “IDERs 102”) may include various energy generation, energy storage, and/or energy distribution systems. The IDERs 102 may further be associated with one or more of one or more energy providers 104a-1041, one or more energy consumers 106a-106n, and one or more energy storage facilities 108a-108p.

The IDERs 102 may include renewable energy sources such as solar panels, wind turbines, and hydropower stations, non-renewable energy sources such as natural gas plants, coal-based power stations, and nuclear power plants, energy storage systems such as batteries or pumped hydro storage, and Distributed Energy Resources (DERs) such as power grids, microgrids, or localized generators. In some embodiments of the present invention, the IDERs 102 may also include hybrid energy systems that may combine multiple energy generation technologies. Embodiments of the present invention may be intended to include or otherwise cover any suitable type of the IDERs 102, including known, related art, and/or later developed technologies that may be beneficial to contribute to energy generation and management.

The computing environment 100 may include the one or more energy providers 104a-1041 (hereinafter referred to as “energy provider 104” or “energy providers 104”). The one or more energy providers 104 may be, for example, traditional power generation plants such as coal-fired, gas-fired, or nuclear power plants, renewable energy sources such as solar farms, wind farms, hydropower plants, and geothermal energy plants, distributed energy resources (DERs) such as rooftop solar panels and small-scale wind turbines, biomass and waste-to-energy facilities, energy storage facilities such as battery storage plants, fuel cell-based energy generation systems, hydrogen power plants, cogeneration or combined heat and power (CHP) units, microgrid operators providing localized energy production, utility companies acting as intermediaries for power distribution, virtual power plants aggregating energy from multiple small-scale sources, tidal and wave energy plants, synthetic fuel-based power plants, energy cooperatives managing shared renewable energy projects, electric vehicle-to-grid (V2G) systems supplying stored energy from EVs, nuclear fusion pilot plants (as emerging technology), and experimental energy sources, such as kinetic or thermoelectric generators.

The energy providers 104 may also include human-powered energy generation systems, such as pedal-powered generators, hand-crank generators, energy harvested from human movement using wearable devices or pressure-sensitive flooring, and so forth. The energy providers 104 may be residential users, commercial establishments, industrial facilities, and so forth, in an embodiment of the present invention. The energy providers 104 may also include energy brokers, energy storage systems, and microgrid operators that may produce, store, or redistribute energy, in another embodiment of the present invention. Additionally, the energy providers 104 may involve entities that may participate in energy lending, energy borrowing, or trading markets. Embodiments of the present invention may be intended to include or otherwise cover any suitable energy providers 104.

Further, the computing environment 100 may include the one or more energy consumers 106a-106n (hereinafter referred to as “energy consumer 106” or “energy consumers 106”). The energy consumers 106 may further include one or more energy-associated machines and/or devices. The one or more energy-associated machines and/or devices may be, for example, heat pumps, Heating, Ventilation, and Air Conditioning (HVAC) systems, electrical appliances such as, refrigerators, washing machines, dishwashers, ovens, and microwaves, generators, electric vehicles, battery storage systems, lighting systems such as LED lights, streetlights, and emergency lighting, air conditioners, water heaters, industrial machinery, such as conveyor belts, pumps, and compressors, automated manufacturing equipment, data centers, computers, mobile phones, smart gadgets, servers, processors, smart home devices, such as, thermostats, smart plugs, and security systems, agricultural equipment, such as irrigation pumps and greenhouse climate control systems, electric forklifts, electric-powered construction tools, electric motors in various applications, medical devices such as oxygen machines, ventilators, diagnostic imaging equipment (e.g., MRI and CT scanners), infusion pumps, patient monitoring systems, and other critical healthcare infrastructure powered by electrical systems and so forth. Embodiments of the present invention may be intended to include or otherwise cover any suitable type of the energy-associated machines and/or devices, including known, related art, and/or later developed technologies.

The energy consumers 106 may be the residential users, the commercial establishments, the industrial facilities, electric vehicle charging stations, healthcare facilities, industries, utility companies, and so forth, in an embodiment of the present invention. The energy consumers 106 may also include the energy brokers, the energy storage systems, and the microgrid operators that may consume, store, or redistribute energy, in another embodiment of the present invention. Additionally, the energy consumers 106 may involve the entities that may participate in energy lending, energy borrowing, or trading markets, as well as those who may seek to optimize their energy usage based on sustainability goals, in yet another embodiment of the present invention. Embodiments of the present invention may be intended to include or otherwise cover any suitable energy consumers 106.

In an embodiment of the present invention, the energy providers 104 and/or the energy consumers 106 may have one or more user devices (not shown). The user devices may enable the energy consumers 106 to interact within the computing environment 100. The user devices may be for example, smartphones, tablets, laptops, desktop computers, displays, screens, smart watches, smart speakers, smart thermostats, Internet-of-Things (IoT)-enabled devices, and so forth. Embodiments of the present invention may be intended to include or otherwise cover any suitable type of the user devices, including known, related art, and/or later developed technologies.

The user devices may enable the energy providers 104 and/or the energy consumers 106 to access and interact with a predictive energy platform 112. Further, the user devices may allow the energy consumers 106 to initiate, stop, monitor, regulate, and optimize energy allocations with the predictive energy platform 112. The user devices may further facilitate communication among the energy providers 104, the energy consumers 106, and the computing environment 100 to enable real-time energy management and control. The user devices may include a user interface for easy communication and interaction with the predictive energy platform 112.

In an embodiment of the present invention, the computing environment 100 may include the one or more energy storage facilities 108a-108p (hereinafter referred to as “energy storage facility 108” or “energy storage facilities 108”). The energy storage facilities 108 may be, for example, battery storage systems, pumped hydro storage facilities, flywheels, Compressed Air Energy Storage (CAES), thermal storage units, supercapacitors, gravity-based storage systems, hydrogen-based storage, Liquid Air Energy Storage (LAES), electrochemical storage, thermochemical energy storage, synthetic fuel storage, cryogenic energy storage, and so forth. Embodiments of the present invention may be intended to include or otherwise cover any suitable type of the energy storage facilities 108, including known, related art, and/or later developed technologies.

According to the embodiments of the present invention, the energy storage facility 108 may be configured to operate dynamically as either the energy sources or the energy consumers 106 based on real-time demand and supply conditions within the computing environment 100. For example, when energy supply exceeds demand, the energy storage facilities 108 may operate as the energy consumers 106 by storing surplus energy. Conversely, during periods of high demand or limited supply, the energy storage facilities 108 may act as energy sources by discharging stored energy back to a grid or the one or more energy consumers 106. An operational mode and energy flow direction of the energy storage facility 108 may be controlled by the predictive energy platform 112, according to some embodiments of the present invention.

The computing environment 100 may include one or more power grids 110 that may be configured to serve as a centralized energy distribution network capable of delivering the energies in the computing environment 100. In an embodiment of the present invention, the one or more power grids 110 may include, for example, high-voltage transmission lines and associated infrastructure that may be designed to transmit electricity from power generation to regional and local distribution networks. The power grid 110 may be configured to interface with the one or more IDERs 102. The interfacing may allow bidirectional energy flow to facilitate the transfer of surplus energy generated by the IDERs 102 back to the power grid 110 or vice versa.

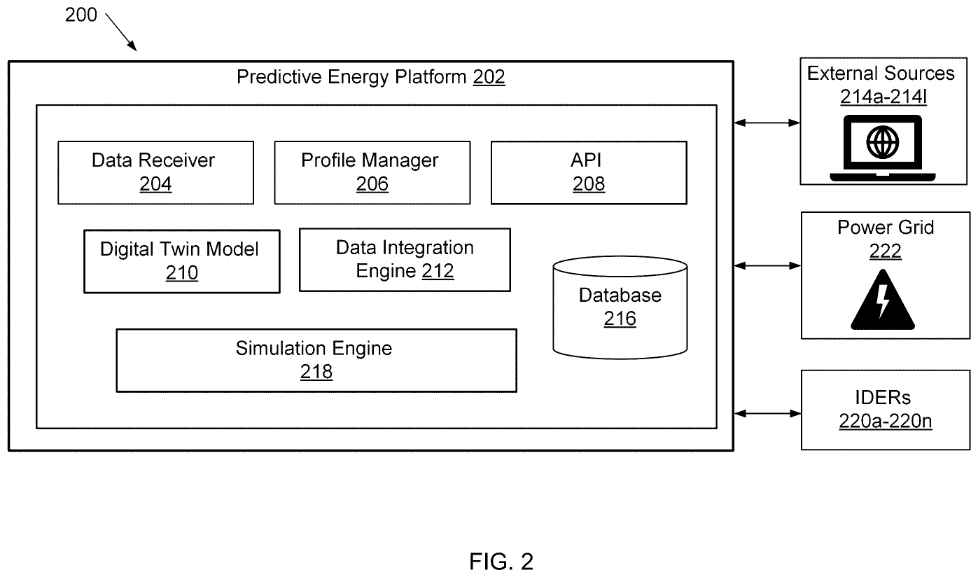

The computing environment 100 may further include a profile manager 114 that may be configured to store energy resource operational attributes of one or more IDERs 102, one or more power grids 110, and so forth. The profile manager 114 may further be configured to compile the energy resource operational attributes in one or more formats suitable for analysis and decision-making by the predictive energy platform 112. The components of the predictive energy platform 112 may be explained in detail in conjunction with FIG. 2.

Further, the computing environment 100 may include a network 116. According to the embodiments of the present invention, the network 116 may enable communication and data exchange across various energy management system users, participants, and components of the computing environment 100.

The network 116 may include a data network such as the Internet, Local Area Network (LAN), Wide Area Network (WAN), Metropolitan Area Network (MAN), etc. In certain embodiments of the present invention, the network 116 may include a wireless network, such as a cellular network, and may employ various technologies including Enhanced Data Rates For Global Evolution (EDGE), General Packet Radio Service (GPRS), Global System For Mobile Communications (GSM), Internet Protocol Multimedia Subsystem (IMS), Universal Mobile Telecommunications System (UMTS), etc. In some embodiments of the present invention, the network 116 may include or otherwise cover networks or sub-networks, that may include, for example, a wired or wireless data pathway. The network 116 may include a circuit-switched voice network, a packet-switched data network, or any other network capable of carrying electronic communications. For example, the network 116 may include networks based on the Internet Protocol (IP) or Asynchronous Transfer Mode (ATM) and may support voice usage, for example, VoIP, Voice-over-ATM, or other comparable protocols used for voice data communications.

Examples of the network 116 may further include a Personal Area Network (PAN), a Storage Area Network (SAN), a Home Area Network (HAN), a Campus Area Network (CAN), a Local Area Network (LAN), a Wide Area Network (WAN), a Metropolitan Area Network (MAN), a Virtual Private Network (VPN), an Enterprise Private Network (EPN), the Internet, a Global Area Network (GAN), and so forth. Embodiments of the present invention may be intended to include or otherwise cover any suitable type of the network 116, including known, related art, and/or later developed technologies to connect the components of the computing environment 100 with each other.

FIG. 2 depicts an exemplary functional block diagram of an energy management system 200. The energy management system 200 may include a predictive energy platform 202 in accordance with at least one embodiment of the present invention. The predictive energy platform 202 (FIG. 2) may be an example of the predictive energy platform 112 (FIG. 1). The predictive energy platform 202 may include components such as at least one data receiver 204, at least one profile manager 206, at least one application programmable interface (API) 208, at least one digital twin model 210, at least one data integration engine 212 configured to at least fetch data from one or more external sources 214a-2141 (hereinafter also referred to as the external source 214, and the external sources 214), at least one database 216, and at least one simulation engine 218.

The components of the predictive energy platform 202 may be configured to utilize the energy resource operational attributes of the IDERs 220a-220n (hereinafter also referred to as the IDER 220, and the IDERs 220) and/or external data from the one or more external sources 214 to generate and/or analyze at least one digital twin of at least one power grid 222. According to the embodiments of the present invention, the predictive energy platform 202 may be configured to simulate real-time energy demand, supply, and performance metrics of one or more IDERs 220 associated with the least one power grid 222.

In at least one embodiment of the present invention, the data receiver 204 may be configured to receive real-time profile data from the one or more IDERs 220. The profile data may include one or more of data related to energy demand, energy generation, energy consumption patterns of the one or more IDERs 220, and so forth. The profile data may further include the energy resource operational attributes of the one or more IDERs 220. The energy resource operational attributes of the one or more IDERs 220 may be operational characteristics, ownership details, historical exchange data, and so forth.

The operational characteristics may include efficiency metrics, power output levels, maintenance schedules, failure rates, response times, and so forth. The ownership details may include details of a registered owner, contractual agreements, leasing, and/or sharing arrangements associated with the IDERs 220. The historical exchange data may include records of past energy exchanges, trading activities, grid contributions, fluctuations in energy supply, energy demand over time, and so forth. Embodiments of the present invention include or otherwise cover any suitable profile data.

By aggregating and analyzing the profile data, the energy management system 200 may enhance decision-making processes related to energy distribution, grid stability, and smart energy trading, ultimately leading to improved sustainability and cost efficiency in energy networks.

The data receiver 204 may further be configured to receive the profile data from external sources, such as the power grid 222 to receive relevant grid data or communicate energy transfer requirements to enable the predictive energy platform 202 to track a flow of the energies across the one or more IDERs and/or the power grid 222. The power grid 222 (FIG. 2) may be an example of the power grid 110 (FIG. 1).

According to at least one embodiment of the present invention, the profile manager 206 may be configured to store the received profile data from the one or more IDERs 220, the power grid 222, and so forth. The profile manager 206 may further be configured to compile the received profile data in one or more formats suitable for analysis and decision-making by the predictive energy platform 202. The profile manager 206 may further be configured to enable authorized energy management system users to at least visualize, using at least one simulation engine 218, the compiled profile data corresponding to the one or more IDERs 220, the power grid 222, and so forth.

According to the embodiment of the present invention, the authorized energy management system users may be, for example, one or more energy managers, one or more energy management system administrators, one or more utility providers, one or more higher authorities, or any other individuals with requisite permissions to monitor the profile data or a part of the compiled profile data. Embodiments of the present invention may be intended to include or otherwise cover any suitable type of the authorized energy management system users.

Further, the profile manager 206 may be configured to transmit the compiled profile data or the part of the compiled profile data to other components of the predictive energy platform 202 such as the at least one digital twin model 210, the at least one data integration engine 212, the at least one database 216, and at least one simulation engine 218 and so forth.

According to at least one embodiment of the present invention, the API 208 may be configured to interface the predictive energy platform 202 for interacting with the one or more IDERs 220. The API 208 may be configured to support functions such as registration of the IDERs 220, transmitting and/or receiving energy management commands, retrieval of the energy resource operational attributes, status monitoring of the one or more IDERs 220, and so forth. Embodiments of the present invention may be intended to include or otherwise cover any suitable functions that may be supported by the API 208, including known, related art, and/or later developed technologies.

According to at least one embodiment of the present invention, the digital twin model 210 may include programming instructions. According to at least one embodiment of the present invention, the digital twin model 210 may be configured to employ a large language model (LLM) or alternatively a small language model (SLM) with at least one context buffer to predict future energy distribution changes. The context buffer may include context data such as prior energy usage patterns, system configuration changes, environmental factors, ongoing adjustments, and so forth. By maintaining the context data, the context buffer may enable the LLM/SLM to generate predictions regarding the future energy distribution changes. For example, the LLM/SLM may be prompted to conduct a trend analysis using the data in the context buffer.

There is a wide range of options regarding the LLMs and SLMs referenced herein. LLMS and SLMs may make use of custom-trained ML models specific to a domain such as time-series forecasting, anomaly detection, and optimization. Graph-based models such as graphical neural networks (GNNs) may be utilized for simulating dynamic energy network topologies. Reinforcement learning techniques are also available for adaptive control and so-called “what-if” scenario analysis. Structured data, and unstructured data, or both from both proprietary and/or external sources may make use of data from LLMs such as energy metrics, weather data, pricing data, and regulations. Machine learning informed optimization techniques can provide the basis for multi-objective optimization including suitable combinations of cost, greenhouse gas emissions, and power supply stability.

In at least one another embodiment of the present invention, the digital twin model 210 may be configured to employ a relational database management system (RDBMS) with linear programming techniques for optimizing power distribution.

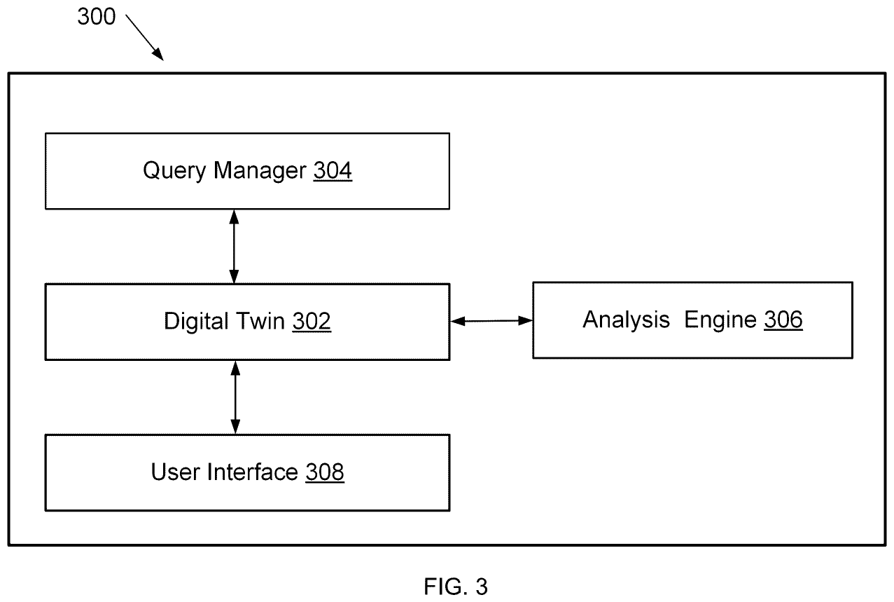

The digital twin model 210 may be configured to generate at least one energy network graph representing at least one power grid 222 based on the energy resource operational attributes of the one or more IDERs 220 received from the profile manager 206. The at least one energy network graph may include one or more nodes and one or more edges. The one or more nodes may be configured to represent the one or more IDERs 220 and the one or more edges may be configured to represent one or more energy exchange pathways among the power grid 222 and the one or more IDERs 220. Further, components and working of the digital twin model 210 may be explained in conjunction with the FIG. 3.

According to at least one embodiment of the present invention, the data integration engine 212 may be configured to fetch the external data from the one or more external sources 214. The data integration engine 212 may be configured to fetch the energy resource operational attributes of the one or more IDERs 220 and/or historical data from the database 216. The data integration engine 212 may further be configured to integrate the energy resource operational attributes of the one or more IDERs 220, the historical data, the external data, and so forth, to the at least one energy network graph. For example, such integration may cause data associations between IDERs, IDER operational attributes, items of historical data, items of external data, and/or elements of energy network graph(s).

Examples of external data may include: pricing, weather conditions, wildfire incidents, grid failures, energy demand forecasts, environmental regulations, market trading data, fuel supply availability, power generation forecasts, disaster alerts, equipment maintenance schedules, voltage and frequency deviations, transformer load conditions, renewable energy output variations, emission levels, cybersecurity threats, grid congestion reports, blackout probabilities, emergency response data, government energy policies, seasonal load fluctuations, consumer energy consumption patterns, infrastructure upgrade schedules, satellite-based environmental monitoring, extreme weather event predictions, and so forth. Embodiments of the present invention may include or otherwise cover any suitable external data for the integration to the at least one network graph, including known, related art, and/or later developed technologies.

According to at least one embodiment of the present invention, the simulation engine 218 may be configured to activate the at least one energy network graph integrated with the external data to simulate the at least one power grid 222. The simulation engine 218 may be configured to process queries received from the energy management system users and/or operators specifying one or more projected modifications to the power grid 222.

According to an exemplary scenario of the present invention, the projected modifications may include adding a new power generator, deploying community batteries, modifying transformer configurations, rerouting power distribution, and so forth. According to another exemplary scenario of the present invention, the projected modifications may involve simulating emergency conditions such as fire outbreaks in a specific region, cyber-attacks, equipment failures, or extreme weather events to analyze their impact on grid stability. The simulations may assess cascading failures, load redistribution strategies, islanding mechanisms, adaptive power rerouting, real-time fault detection, automated restoration protocols, and emergency response coordination with disaster management teams to enhance grid resilience and operational efficiency.

The simulation engine 218 may further be configured to generate at least one impact output based on the projected modifications. The at least one impact output may be displayed to the energy management system users and/or energy management system operators for visualization of one or more of energy distribution changes, hotspot detection within the power grid 222, cost-benefit analysis of the projected modifications, grid stability assessment, emission reduction estimates, load balancing predictions, and so forth. The simulation engine 218 may further be configured to employ a machine learning (ML) technique(s), the LLM, and/or linear programming-based optimization models for predictive analysis.

According to at least one embodiment of the present invention, the simulation engine 218 may be configured to enable a “what-if” analysis. The simulation engine 218 may be configured to analyze user-defined hypothetical scenarios to evaluate one or more impacts of the projected modifications. The user-defined hypothetical scenarios may be projected by the energy management system users via the user interface.

The simulation engine 218 may further be configured to suggest optimal configurations for maximizing energy efficiency, reducing costs, and/or improving grid resilience. The simulation engine 218 may further be configured to store the evaluated impacts of the projected modifications in the database 216 for historical tracking and/or further analysis.

According to an exemplary scenario of the present invention, the simulation engine 218 may simulate the digital twin of the power grid 222 to simulate one or more hotspots within the power grid 222 based on real-time and the historical data. The hotspot may be identified when a particular region within the power grid 222 exhibits a high power demand, a voltage instability, a transformer overload, or a network congestion. In another embodiment of the present invention, the hotspots may indicate a risk of the power failure, an energy inefficiency, a supply-demand imbalance, and so forth.

For example, a major industrial zone may experience a sudden increase in the energy demand due to peak production hours, the simulation engine 218 may simulate the digital twin of the power grid 222 to simulate historical consumption patterns, current transformer load conditions, and the real-time external factors such as the extreme temperatures and/or reduced renewable energy availability. If a power draw exceeds the transformer capacity, the hotspot may be flagged, and the simulation engine 218 may be configured to display visual markers and/or the alert symbols for indicating a potential power outage or the system failure risk.

According to at least one embodiment of the present invention, the simulation engine 218 may further be configured to simulate the digital twin of the power grid 222 to simulate the future impact of the one or more hotspots. The simulation engine 218 may further be configured to simulate the digital twin of the power grid 222 to simulate potential consequences of different grid conditions, such as power redistribution scenarios, renewable energy fluctuations, emergency load adjustments, and so forth.

According to at least one embodiment of the present invention, the simulation engine 218 may be configured to simulate the digital twin of the power grid 222 to simulate the “what-if” analysis by testing different mitigation strategies in the digital twin model 210 before implementing the mitigation strategies in the power grid 222. The user interface may be configured to display the real-time simulations of the scenarios related to the hotspots to allow the grid operators, the energy managers, and/or the energy management system administrators to analyze the potential impact of different conditions.

According to at least one embodiment of the present invention, the database 216 may be configured to store the one or more generated digital twins corresponding to the power grid 222. The database 216 may further be configured to store energy-related data, such as the one or more aggregated profiles, including the charts of accounts, one or more cryptographic certificates, metadata associated with the one or more cryptographic certificates, and so forth. In an embodiment of the present invention, the database 216 may be configured to store occurrences of the hotspot, root causes of the hotspot occurrences, and the performance outcomes for improving a future decision-making and/or predictive capabilities of the digital twin model. Embodiments of the present invention may be intended to include or otherwise cover any suitable type of data in the database 216, including known, related art, and/or later developed technologies.

In an embodiment of the present invention, the database 216 may be a Relational Database Management System (RDBMS), such as MySQL or PostgreSQL, that may be used to store structured data of the one or more aggregated profiles, or the energy-related data with fixed relationships. In another embodiment of the present invention, the database 216 may be a NoSQL database that may be employed to handle large volumes of unstructured or semi-structured data. In a further embodiment of the present invention, the database 216 may be a Graph Database (e.g., Neo4j), an Object-Oriented Database, a Distributed Database (e.g., Cassandra), a Cloud-Based Database, such as Amazon RDS or Google Cloud SQL, and so forth. Embodiments of the present invention may be intended to include or otherwise cover any suitable type of the database 216, including known, related art, and/or later developed technologies. Further, working of the components of the predictive energy platform 202 may be explained in conjunction with FIG. 3.

FIG. 3 illustrates an exemplary functional diagram of a simulation engine 300 in accordance with at least one embodiment of the present invention. In at least one embodiment of the present invention, the simulation engine 300 may include a digital twin 302, a query manager 304, an analysis engine 306, and a user interface 308. The digital twin 302 may be configured to represent a virtual model of a power grid (i.e., the power grid 222) to provide the simulation of a real-time energy management environment.

The query manager 304 may be configured to receive and process input queries from the energy management system users and/or other systems. The queries may include the projected modifications and/or adjustments to the power grid. The query manager 304 may further be configured to manage query-related parameters such that the received queries may be aligned with the simulated real-time energy management environment. The query manager 304 may be configured to analyze the context data and intent of the input queries, validate the feasibility of the proposed modifications, and map the proposed modifications with relevant energy resource operational attributes of the IDERs. The query manager 304 may leverage machine learning algorithms and the historical data to predict the impact of suggested changes such that the simulations on the digital twin 302 may accurately reflect real-world grid behavior corresponding to the power grid.

Additionally, the query manager 304 may dynamically adjust simulation parameters, incorporate real-time grid status updates, and enforce predefined constraints to ensure system stability. The query manager 304 may also be configured to prioritize and schedule queries based on urgency, regulatory requirements, and ongoing operational scenarios.

According to at least one embodiment of the present invention, the projected modification may include, adding a new power generator, deploying community batteries, modifying transformer configurations, rerouting power distribution, and so forth.

According to at least one embodiment of the present invention, the analysis engine 306 may be configured to process the received queries through the simulation engine 300. The analysis engine 306 may be configured to generate one or more analysis products by simulating the digital twin 302 of the power grid. Examples of the analysis products include: an impact output, a predictive failure assessment, a predictive success assessment, a load distribution analysis, a stability report, and so forth. Embodiments of the present invention include or otherwise cover any suitable type of the analysis products, including known, related art, and/or later developed technologies.

The analysis engine 306 may be configured to generate the at least one impact output corresponding to the projected modification. The impact output may include energy distribution changes, the hotspot detection within the power grid, a cost-benefit analysis of the projected modifications, a Grid stability assessment, and so forth. Embodiments of the present invention include or otherwise cover any suitable type of the impact output for the projected modifications, including known, related art, and/or later developed technologies.

The simulation engine 300 may be further configured to transmit the generated impact output to the user interface 308, enabling graphical visualizations, such as network flow diagrams, energy balance reports, power outage forecasts, grid efficiency improvements, sustainability metrics, and others, for display. The user interface 308 may also be configured to receive inputs from the authorized energy management system users, such as energy managers, the energy management system administrators, campus facility operators, or utility providers, for refining and adjusting the simulation parameters.

According to at least one embodiment of the present invention, the simulation engine 300 may be configured to operate in real-time to continuously update the energy network graph based on dynamic external conditions, including fluctuations in renewable energy production, real-time grid congestion reports, emergency response activations, regulatory changes, and so forth. The simulation engine 300 may also be configured to receive at least one recommendation using the analysis engine 306. The analysis engine 306 may be configured to suggest optimal updates to the simulation engine 300, such as preventive load adjustments, demand-side energy optimizations, infrastructure reinforcements, and so forth.

The analysis engine 306 may be configured to detect potential failures within the power grid by monitoring real-time voltage and frequency deviations, load forecasting anomalies, predictive maintenance trends, and other relevant indicators. Upon detecting a potential failure, the analysis engine 306 may be configured to generate at least one recommendation for mitigating power disruptions and/or enhancing grid resilience.

According to an exemplary scenario of the present invention, the query manager 304 may be configured to receive an IDER removal query to remove the IDER from the power grid. The query manager 304 may be configured to process the IDER removal query by analyzing the context data, validating the feasibility, and mapping the removal with relevant energy resource operational attributes. The analysis engine 306 may be configured to generate the impact output corresponding to the removal. The impact output in this exemplary scenario may be, for example energy distribution changes, the hotspot detection within the power grid, cost-benefit analysis, grid stability assessment, and so forth.

The analysis engine 306 may further be configured to generate the load distribution analysis to assess power imbalances resulting from the removal of the IDER. The grid stability assessment may be configured to determine whether the removal of the IDER may introduce an instability that may require preventive load adjustments or reinforcement measures.

The simulation engine 300 may be further configured to detect potential hotspots in which energy demand exceeds supply may lead to stress on remaining power sources. Upon detecting a potential grid imbalance, the analysis engine 306 may be configured to generate at least one recommendation for mitigating disruptions, including dynamic load balancing, alternative routing strategies, or infrastructure reinforcements. The simulation engine 300 may also be configured to transmit the impact output to the user interface 308 for enabling the graphical visualization of affected energy network zones and/or real-time adjustments to operational parameters.

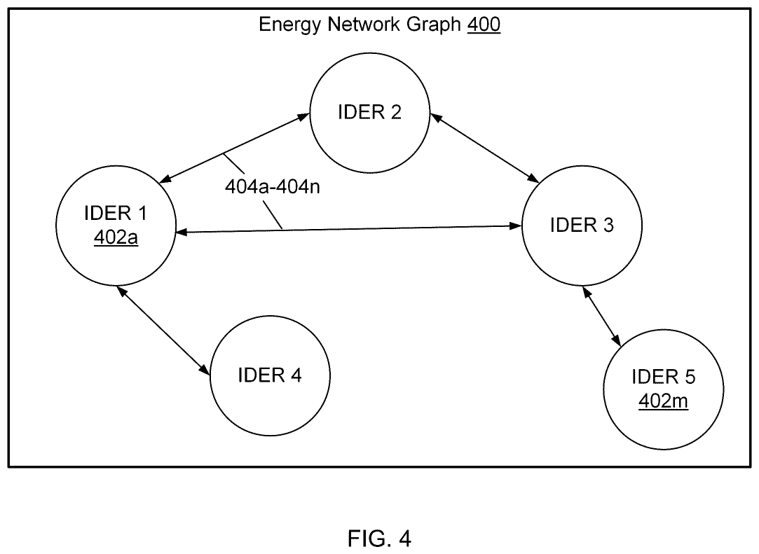

According to at least one embodiment of the present invention, the user interface 308 of the predictive energy platform may be configured to provide the energy management system users with an intuitive interface for visualizing and/or simulating operations of the power grid. The user interface 308 may be configured to facilitate a real-time visualization of the energy generation, the energy consumption, and the energy transfer across the system, allowing the energy management system users to monitor and control various energy-related parameters. The user interface 308 may further be configured to enable the users to adjust settings, review system status, and receive notifications about energy allocation changes, performance metrics, or system alerts. Additionally, the user interface 308 may include a dashboard (not shown) to visualize the energy consumption patterns across the one or more IDERs 220. Moreover, the user interface 308 may support interactive features like drag-and-drop scheduling, such as the energy management system users may adjust energy transfer schedules and/or may modify operating priorities of specific IDERs and/or loads. The user interface 308 may also be configured to display predictive analytics, and forecasts for energy demand and generation, according to the embodiments of the present invention. FIG. 4 is an exemplary energy network graph 400 in accordance with at least one embodiment of the present invention. In at least one embodiment of the present invention, the energy network graph 400 may provide a graphical depiction of interconnected IDERs (i.e., IDERs 220) of the power grid (i.e., power grid 222). The energy network graph 400 may be configured to display nodes 402a-402m that may represent the interconnected IDERs such as energy generation sources (e.g., renewable generators, conventional power plants, and distributed energy resources), energy storage devices (e.g., community batteries), distribution centers, and energy loads (e.g., buildings, industrial consumers, or campus facilities). The nodes 402a-402m within the energy network graph 400 may be interconnected by edges 404a-404n that may represent physical and/or logical connections, such as power transmission lines, distribution circuits, or data communication links. In some embodiments of the present invention, the edges 404a-404n may be visually differentiated using color coding or distinct line styles to indicate characteristics such as energy flow direction, transmission efficiency, or load intensity. Further, the edges 404a-404n may be dynamic and/or animated to reflect real-time changes in energy distribution, such as fluctuating power demands, varying load conditions, or grid reconfiguration events.

Further, in some embodiments of the present invention, the energy network graph 400 may include interactive features to allow the energy management system users and/or the operators to view detailed analytics associated with the one or more nodes 402a-402m and/or the one or more edges 404a-404n, such as real-time power levels, efficiency metrics, or historical trends. Embodiments of the present invention may be intended to include or otherwise include any suitable visualization techniques for the nodes 402a-402m and/or the edges 404a-404n, including known, related art, and/or later developed technologies.

In some embodiments of the present invention, the energy network graph 400 may incorporate dynamic indicators such as numerical values, graphical overlays, or real-time data feeds that may be configured to reflect parameters including energy generation, consumption, and transfer across the energy management system 200. These indicators may be continuously updated to enable real-time monitoring of grid performance. The energy network graph 400 may further include the visual markers and/or the alert symbols to indicate anomalous conditions, such as voltage fluctuations, potential overloads, or the hotspots that may emerge after inputting the projected modifications. The visual markers may be configured to serve as cues for the energy management system users and/or the operators to investigate the nodes 402a-402m or connections more thoroughly.

In at least one embodiment of the present invention, the energy network graph 400 may be interactive and/or may be configured to allow the authorized energy management system users to zoom, pan, and select specific nodes or edges to access detailed energy metrics, performance data, and predictive analytics. Moreover, the energy network graph 400 may be configured to integrate overlays of recommended system modifications such as preventive load adjustments, demand-side energy optimizations, or infrastructure reinforcements to enable the energy management system users to visualize the potential impact of such projected modifications directly on the energy network graph 400.

In some embodiments of the present invention, the energy network graph 400 may further be configured to enable a visualization of the historical data that may be configured to enable the energy management system users to review past performance trends, analyze events associated with system anomalies, and/or assess the effectiveness of previously projected modifications.

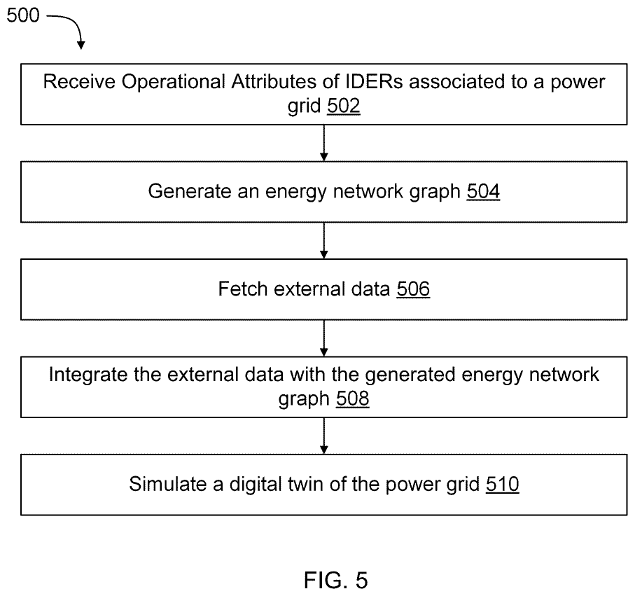

FIGS. 5-7 present illustrative one or more processes 500-700 for implementing predictive energy management systems in accordance with at least one embodiment of the present invention. It is to be understood that the processes 500-700, as illustrated in the FIGS. 5-7, may be described in accordance with at least one embodiment of the present invention without direct reference to specific numerals of the components depicted corresponding to the predictive energy platform 112 (FIG. 1), or the predictive energy platform 202 (FIG. 2). The omission of specific numerals for components in describing the processes 500-700 may not limit the scope of the invention, and the processes 500-700 may be implemented using any suitable configuration or arrangement of the components described in the predictive energy platform 112 (FIG. 1), or the predictive energy platform 202 (FIG. 2).

The one or more processes 500-700 may be illustrated as a collection of blocks in a logical flowchart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations may be described may not be intended to be construed as a limitation, and any suitable number of the described blocks may be combined in any suitable order and/or in parallel to implement the process.

FIG. 5 is an exemplary process 500 of generating a digital twin in accordance with at least one embodiment of the present invention.

At 502 block, the predictive energy platform may be configured to receive the energy resource operational attributes of the one or more IDERs that may be associated with a power grid. The energy resource operational attributes may include, for example, energy generation capacity, energy consumption patterns, ownership details, historical exchange data, geographical location, and so forth. The energy resource operational attributes may be retrieved from the profile manager and stored in the database for generating the digital twin using the digital twin model.

At 504 block, the predictive energy platform may be configured to generate an energy network graph that may be configured to include one or more nodes corresponding to the one or more IDERs and one or more edges representing energy exchange pathways. The energy network graph may further include energy flow data, load balancing information, power constraints, network efficiency metrics, and so forth. The digital twin model may be configured to store the generated network graph in the database for subsequent analysis.

At 506 block, the predictive energy platform may be configured to fetch the external data using the profile manager and/or the API. The external data may be, for example, energy pricing, weather conditions, grid failures, disaster alerts, renewable energy availability, regulatory policies, fuel supply status, carbon emission levels, cybersecurity risks, energy trading market fluctuations, and so forth. The data integration engine may be configured to fetch external data from the one or more external sources for elevating the energy network graph.

At 508 block, the predictive energy platform may be configured to integrate the fetched external data with the energy network graph. The data integration engine may be configured to merge the energy resource operational attributes, the historical data, and the external data to the energy network graph for benefit of real-time power grid simulation and predictive analytics.

At 510 block, the predictive energy platform may be configured to simulate a digital twin of the power grid. The simulation engine may be configured to model real-time power distribution scenarios, predict energy demand fluctuations, optimize power flow across network nodes, analyze the impact of renewable energy integration, and so forth. The user interface may be configured to display the simulated digital twin and allow the authorized energy management system users to conduct what-if analysis for grid optimization.

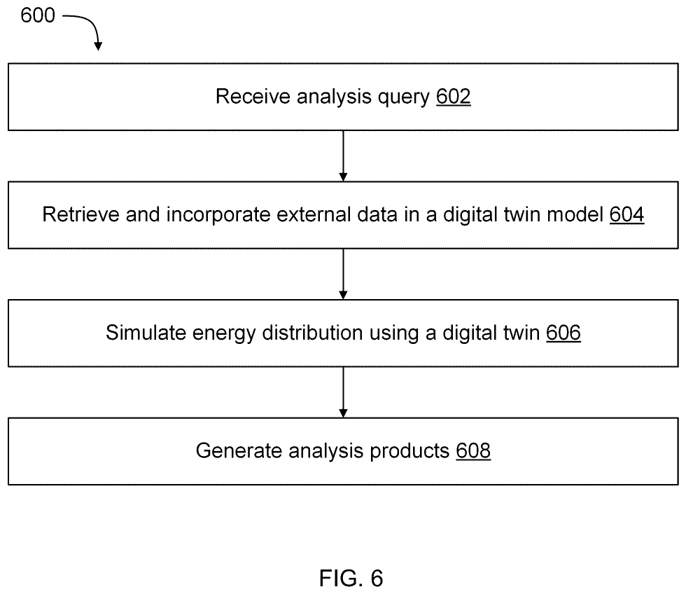

FIG. 6 is an exemplary process 600 of generating analysis products using a digital twin in accordance with at least one embodiment of the present invention.

At 602 block, the predictive energy platform may be configured to receive a query using a query manager. The query may specify at least one projected modification to the power grid, wherein the modification may include adding a new power generator, deploying energy storage systems, upgrading transformer configurations, rerouting power distribution, and so forth.

At 604 block, the predictive energy platform may be configured to retrieve and/or incorporate the external data in the digital twin model. The data integration engine may be configured to fetch the external data from the external sources, and the profile manager may retrieve the historical data and the energy resource operational attributes of the one or more IDERs for benefit of validating the feasibility of the requested query.

At 606 block, the predictive energy platform may be configured to simulate an energy network graph that may be configured to include projected modifications. The simulation engine may apply optimization techniques, including linear programming for cost efficiency, machine learning models for predictive demand forecasting, power flow simulations for stability assessment, and so forth.

At 608 block, the predictive energy platform may be configured to generate the one or more analysis products based on the simulated energy network graph using the analysis engine. The analysis engine may be configured to compute grid resilience metrics, energy cost savings reports, the hotspot detection and risk assessments, load balancing strategies, emission reduction estimates, and so forth. The user interface may be configured to display the generated analysis products in a visual dashboard for the authorized energy management system users.

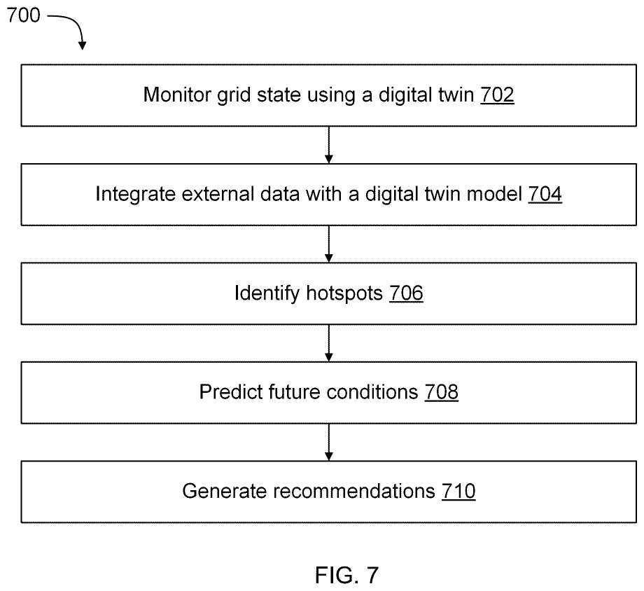

FIG. 7 is an exemplary process 700 of detecting impact using a digital twin in accordance with at least one embodiment of the present invention.

At 702 block, the predictive energy platform may be configured to monitor a grid state using the digital twin. The digital twin may be configured to enable the energy management system users to track real-time voltage, frequency stability, detect power surges, demand spikes, monitor renewable energy integration efficiency, assess infrastructure health, and so forth.

At 704 block, the predictive energy platform may be configured to integrate the external data with the digital twin model using the data integration engine. The data integration engine may be configured to fetch the real-time external data from the external sources. The data integration engine may be configured to merge the fetched real-time external data into the digital twin model for the benefit of continuous updates to grid simulations.

At 706 block, the predictive energy platform may be configured to identify hotspots. The analysis engine may process the real-time and the historical data to locate areas prone to power outages, overloaded transformers, voltage instability, grid congestion, and so forth. The user interface may be configured to display identified hotspots using heatmaps and graphical alerts.

At 708 block, the predictive energy platform may be configured to predict future conditions. The predictive energy platform may be configured to forecast energy demand growth, evaluate seasonal load fluctuations, simulate long-term effects of infrastructure changes, assess climate change impact on grid performance, and so forth. The predictive energy platform may be configured to employ a large language model-based predictive system or a linear programming-based optimizer for generating the future condition predictions.

At 710 block, the predictive energy platform may be configured to generate recommendations based on the detected impact. The analysis engine may process insights and generate optimization strategies, including load redistribution strategies, renewable energy deployment recommendations, infrastructure upgrades, demand response management, cost-benefit optimizations, and so forth. The user interface may be configured to present recommendations to the authorized energy management system users in interactive reports and dashboards.

The processes 500-700 may include examples where the predictive energy management system may facilitate efficient energy management across the multiple microgrids of the plurality of disparate facilities. These examples are intended to illustrate the nature of predictive energy management and should not be construed as restrictive.

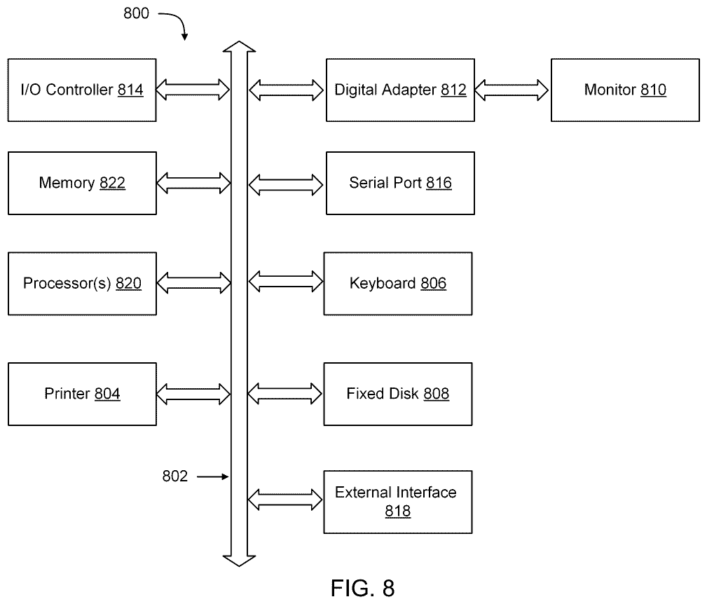

FIG. 8 a schematic diagram illustrating aspects of an example computer in accordance with at least one embodiment of the present invention. In accordance with at least some embodiments, the system, apparatus, methods, processes and/or operations for message coding may be wholly or partially implemented in the form of a set of instructions executed by one or more programmed computer processors such as a central processing unit (CPU) or microprocessor. Such processors may be incorporated in an apparatus, server, client, or other computing device operated by, or in communication with, other components of the system.

As an example, the FIG. 8 depicts aspects of elements that may be present in a computer device and/or system 800 configured to implement a method and/or process in accordance with some embodiments of the present invention. The subsystems shown in FIG. 8 are interconnected via a system bus 802. Additional subsystems such as a printer 804, a keyboard 806, a fixed disk 808, and a monitor 810, which is coupled to a display adapter 812. Peripherals and input/output (I/O) devices, which couple to an I/O controller 814, may be connected to the computer system by any number of means known in the art, such as a serial port 816. For example, the serial port 816 or an external interface 818 may be utilized to connect the computer device 800 to further devices and/or systems not shown in FIG. 8 including a wide area network such as the Internet, a mouse input device, and/or a scanner. The interconnection via the system bus 802 may allow one or more processors 820 to communicate with each subsystem and to control the execution of instructions that may be stored in a system memory 822 and/or the fixed disk 808, as well as the exchange of information between subsystems. The system memory 822 and/or the fixed disk 808 may embody a tangible computer-readable medium.

It should be understood that the present invention as described above may be implemented in the form of control logic using computer software in a modular or integrated manner. Alternatively, or in addition, embodiments of the invention may be implemented partially or entirely in hardware, for example, with one or more circuits such as electronic circuits, optical circuits, analog circuits, digital circuits, integrated circuits (“IC”, sometimes called a “chip”) including application-specific ICs (“ASICs”) and field-programmable gate arrays (“FPGAs”), and suitable combinations thereof. As will be apparent to one of skill in the art, notions of computational complexity and computational efficiency may be applied mutatis mutandis to circuits and/or circuitry that implement computations and/or algorithms. Based on the disclosure and teachings provided herein, a person of ordinary skill in the art will know and appreciate other ways and/or methods to implement the present invention using hardware and/or a combination of hardware and software.

Any of the software components, processes, or functions described in this application may be implemented as software code to be executed by a processor using any suitable computer language such as, for example, Java, C++, or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

According to the embodiments of the present invention, the predictive energy management systems may include the one or more processor 820 and the memory 820 for storing instructions. In such an embodiment of the present invention, the instructions stored in the memory 820 may be executed by the memory 820 to perform a set of operations of the predictive energy management system.

The instructions may be in the form of packages of a computer program code. The code, for example, may be written in a computer programming language that may be compiled into a native instruction set of the one or more processor 820. Further, the code may also be written directly using the native instruction set (e.g., machine language) for executing a set of operations. The set of operations may typically include comparing two or more units of information, shifting positions of units of information, and combining two or more units of information, such as by addition or multiplication or logical operations like OR, exclusive OR (XOR), and AND. Each operation of the set of operations that can be performed by the one or more processor 820 may be represented to the one or more processor 820 by information called instructions, such as an operation code of one or more digits. A sequence of operations to be executed by the one or more processor 820, such as a sequence of operation codes, constitutes processor instructions, also called computer system instructions or, simply, computer instructions. The one or more processor 820 may be implemented as mechanical, electrical, magnetic, optical, chemical, or quantum components, among others, alone or in combination. Embodiments of the present invention may be intended to include or otherwise cover any suitable implementation of the one or more processor 820, including known, related art, and/or later developed technologies.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein may be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the present invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for generating a predictive digital twin for at least one power grid, comprising:
receiving one or more energy resource operational attributes, from at least one profile manager, corresponding to a plurality of integrated distributed energy resources (IDERs);
generating, using at least one digital twin model, at least one digital twin of the at least one power grid at least in part by creating at least one energy network graph based on the received one or more energy resource operational attributes corresponding to the plurality of IDERs; and
integrating external data with the at least one generated energy network graph for generating at least one analysis product.

2. The method of claim 1, further comprising storing the at least one generated energy network graph in at least one database for generating the at least one analysis product.

3. The method of claim 1, wherein the at least one generated energy network graph comprises:
one or more nodes configured to correspond to the plurality of IDERs; and
edges configured to represent one or more energy exchange pathways relating to the one or more nodes.

4. The method of claim 1, further comprising fetching the external data from one or more external sources via at least one data integration engine.

5. The method of claim 1, further comprising receiving at least one query specifying at least one projected modification to the at least one power grid.

6. The method of claim 5, further comprising simulating at least one impact output of the at least one projected modification using the at least one digital twin model.

7. The method of claim 6, further comprising displaying the at least one impact output via at least one user interface.

8. The method of claim 1, wherein the digital twin model is configured to employ a large language model (LLM) with at least one context buffer to predict one or more energy distribution changes corresponding to the at least one power grid.

9. The method of claim 1, further comprising detecting at least one hotspot within the at least one power grid by integrating the external data with the at least one generated energy network graph.

10. A predictive energy platform for generating a predictive digital twin for at least one power grid, comprising:
at least one profile manager configured to receive one or more one or more energy resource operational attributes corresponding to a plurality of integrated distributed energy resources (IDERs), wherein the one or more energy resource operational attributes include at least one of: an operational characteristic, an ownership details, and historical exchange data;
at least one digital twin model configured to correspond to at least one digital twin of the at least one power grid at least in part by incorporating at least one energy network graph based on the received one or more energy resource operational attributes corresponding to the plurality of IDERs; and
at least one data integration engine configured to incorporate external data with the at least one generated energy network graph for generating at least one analysis product.

11. The predictive energy platform of claim 10, further comprising at least one database configured to store the at least one generated energy network graph for generating the at least one analysis product.

12. The predictive energy platform of claim 10, wherein the at least one generated energy network graph comprises:
one or more nodes configured to correspond to the plurality of IDERs; and
edges configured to represent one or more energy exchange pathways relating to the one or more nodes.

13. The predictive energy platform of claim 10, wherein the data integration engine is configured to fetch the external data from one or more external sources.

14. The predictive energy platform of claim 10, further comprising at least one query manager configured to receive a query specifying at least one projected modification to the at least one power grid.

15. The predictive energy platform of claim 10, further comprising at least one analysis engine configured to generate at least one impact output of the at least one projected modification using the at least one digital twin model.

16. The predictive energy platform of claim 15, wherein the at least one analysis engine is configured to detect at least one hotspot within the at least one power grid based on the integrated external data with the at least one generated energy network graph.

17. The predictive energy platform of claim 10, further comprising a user interface configured to display the at least one impact output.

18. The predictive energy platform of claim 10, wherein the at least one digital twin model comprises a large language model (LLM) with at least one context buffer to predict one or more energy distribution changes corresponding to the at least one power grid.

19. One or more computer-readable media, collectively storing instructions that, when executed by one or more processors, collectively cause one or more computing devices to, at least:
receive one or more energy resource operational attributes, from at least one profile manager, corresponding to a plurality of integrated distributed energy resources (IDERs);
generate, using at least one digital twin model, at least one digital twin of the at least one power grid at least in part by creating at least one energy network graph based on the received one or more energy resource operational attributes corresponding to the plurality of IDERs; and
integrate external data with the at least one generated energy network graph for generating at least one analysis product.

20. The one or more computer-readable media of claim 19, wherein the instructions further cause the one or more computing devices to store at least one generated energy network graph in at least one database for generating the at least one analysis product.
